(19) United States
(12) Patent Application Publication
(10) Pub. No.: US 2024/0283273 A1
(43) Pub. Date: Aug. 22, 2024

(54) CHARGING CONTROL METHOD OF BATTERY PACK AND BATTERY SYSTEM USING THE SAME

(71) Applicant: LG ENERGY SOLUTION, LTD., Seoul (KR)

(72) Inventors: Incheol YEOM, Daejeon (KR); Nari KIM, Daejeon (KR); Jeonghyeon IN, Daejeon (KR)

(73) Assignee: LG ENERGY SOLUTION, LTD., Seoul (KR)

(21) Appl. No.: 18/563,732

(22) PCT Filed: Dec. 29, 2022
(86) PCT No.: PCT/KR2022/021601

§ 371 Date: Nov. 22, 2023

(30) Foreign Application Priority Data
Jan. 6, 2022 (KR) 10-2022-0002136

(51) Int. Cl. H02J 7/00; G05B 19/4155; H01M 10/42

(52) U.S. Cl. CPC H02J 7/00712; G05B 19/4155; H01M 10/425; H02J 7/0013; H02J 7/0048; H02J 7/007194; G05B 2219/42033; H01M 2010/4271

(57) ABSTRACT

A battery system may include: a battery pack including a plurality of battery cells; and a battery management system configured to derive a charging rate based on a charging target state of charge (SOC) for the battery pack and the temperature of the battery pack, and compensate for the charging rate through proportional-integral-derivative (PID) control based on an error voltage between any one of a plurality of cell voltages of the plurality of battery cells and an open circuit voltage (OCV) corresponding to the charging target SOC to generate a compensation charging rate.

### CROSS-REFERENCE TO RELATED APPLICATION

This application claims priority to and the benefit of Korean Patent Application No. 10-2022-0002136 filed in the Korean Intellectual Property Office on Jan. 6, 2022, the entire contents of which are incorporated herein by reference.

### TECHNICAL FIELD

The present disclosure relates to a charging control method of a battery pack and a battery system using the same.

### BACKGROUND ART

Existing fast charging methods operate based on a rapid charging map composed of fixed C-rates according to a state of charge (SOC) and a temperature. For example, a battery management system (BMS) receives a target SOC and a current temperature as initial conditions, and determines a C-rate (e.g., a rate at which a battery is discharged relative to its maximum capacity, where 1C equates to a fully charged battery rated at 1Ah provides 1A for one hour, as known in the art) corresponding to the initial conditions on a rapid charging map. The BMS transmits the determined C-rate value to the vehicle or a cycler (e.g., scooter or the like), and the vehicle or cycler performs the rapid charging by applying the current to the battery cell or the module according to the transmitted C-rate. A drawback of this method is that the effect caused by the degeneration of the cell cannot be considered in the rapid charging process. In general, when the cell degenerates, since an internal resistance increases, a larger voltage is output at the same SOC compared to the initial production time. Due to this, the cell voltage may exceed an upper limit voltage that should not be exceeded during the rapid charging process. The upper limit voltage may be different depending on the SOC level.

The phenomenon of exceeding the upper limit voltage due to the cell degeneration continues to occur as the number of the rapid charging cycles is repeated, which has a negative effect of further accelerating the cell degeneration. When the cell voltage exceeding the upper limit voltage occurs, there is an improvement method to reduce the current magnitude to a certain ratio. However, since it is impossible to predict the voltage change due to the cell degeneration due to various factors, a method of reducing the current magnitude to a constant ratio is not effective.

### DISCLOSURE

### Technical Problem

The present disclosure is intended to provide a charging control method for a battery pack that may prevent the phenomenon of exceeding the upper limit voltage due to the cell degeneration in advance while maintaining the rapid charging speed as much as possible.

### Technical Solution

A battery system may include: a battery pack including a plurality of battery cells; and a battery management system configured to derive a charging rate based on a charging target state of charge (SOC) for the battery pack a temperature of the battery pack, and compensate for the charging rate through proportional-integral-derivative (PID) control based on an error voltage between any one of a plurality of cell voltages of the plurality of battery cells and an open circuit voltage (OCV) corresponding to the charging target SOC to generate a compensation charging rate.

The battery management system may generate a proportional value, an integral value, and a differential value based on the error voltage to derive a PID value, and multiplies the charging rate by the PID value to generate the compensation charging rate.

The battery management system may derive the PID value by adding the proportional value, the integral value, and the differential value.

The battery management system may include a charging rate map in which a charging rate corresponding to each temperature of a plurality of battery packs is defined for each of a plurality of charging targets SOCs, and receives the charging target SOC and the temperature of the battery pack, and derives the charging rate corresponding to the received charging target SOC and battery pack temperature from the charging rate map.

The battery management system may generate the OCV corresponding to the charging target SOC by using an SOC to OCV conversion function.

The battery management system may generate the error voltage by subtracting a highest cell voltage among the plurality of cell voltages from the OCV.

The battery system includes battery cell groups including battery cells among the plurality of battery cells connected in parallel, and the battery cell groups are connected to each other in series, and the battery management system may generate a modulation charging rate by multiplying the compensation charging rate by the number of battery cell groups.

A charging method of a battery pack including a plurality of battery cells controlled by a battery management system, may include: deriving a charging rate based on a charging target state of charge (SOC) for the battery pack and a temperature of the battery pack; generating an error voltage between any one of a plurality of cell voltages and an open circuit voltage (OCV) corresponding to the charging target SOC; and generating a compensation charging rate by compensating for the charging rate through proportional-integral-derivative (PID) control based on the error voltage.

The generating of the compensation charging rate may include: generating a proportional value, an integral value, and a differential value based on the error voltage; deriving the PID value by adding the proportional value, the integral value, and the differential value; and multiplying the charging rate by the PID value to generate the compensation charging rate.

The driving of the charging rate may include: receiving the charging target SOC and the temperature of the battery pack; and deriving the charging rate corresponding to the received charging target SOC and battery pack temperature from a charging rate map.

The charging control method of the battery pack may further include generating the OCV corresponding to the charging target SOC by using an SOC to OCV conversion function.

The generating of the error voltage may include generating the error voltage by subtracting a highest cell voltage among the plurality of cell voltages from the OCV.

The battery system includes battery cell groups including battery cells among the plurality of battery cells connected in parallel, and the battery cell groups are connected to each other in series, and the charging control method of the battery pack may further include generating a modulation charging rate by multiplying the compensation charging rate by the number of battery cell groups.

### Advantageous Effects

The present disclosure provides the method for controlling the charging of the battery pack, and the battery system using the method so that the cell voltage does not exceed the upper limit voltage.

### DESCRIPTION OF THE DRAWINGS

FIG. 1 is a view showing a battery system according to an embodiment.

FIG. 2 is a block diagram showing some components of a BMS according to an embodiment.

FIG. 3 is a flowchart showing an operation of a BMS according to an embodiment.

FIG. 4 is a block diagram showing a configuration of a BMS according to an embodiment.

FIG. 5 is a circuit diagram showing a battery pack according to an embodiment.

### MODE FOR INVENTION

An embodiment of the present disclosure may control a charging speed through PID control based on a charging target SOC and a cell voltage in order to prevent a cell from exceeding an upper limit voltage during charging. The PID control applied to an embodiment is a well-known control method, but by being applied to an embodiment, a heterogeneous effect capable of preventing an upper limit voltage exceeding phenomenon of a cell during the charging may be provided. The PID (Proportional-Integral-Differential) control is a form of negative feedback control, which measures an output value of a controlled object, compares it with a reference value based on a control target to calculate an error, and uses a proportional term, an integral term, and a differential term by this error value, so that a control value (hereinafter, a PID value) required to control a control target may be calculated. In an embodiment, the output value may be a cell voltage, the reference value may be an OCV (Open Circuit Voltage) corresponding to the charging target SOC, and the PID value may be a weight value multiplied by a charging speed. The proportional term may be a value proportional to the magnitude of the error value in the current state, the integral term may eliminate a steady-state error, and the differential term may reduce an overshoot and improve stability by braking sudden changes in the output value.

The charging speed may be expressed as a charging rate (C-rate) hereinafter. The charging rate (C-rate) means a magnitude of a charging current ([A]) or a discharging current ([A]) for a rated capacity of the battery when charging or discharging, and “C” is used for the “unit” of the C-rate. This is expressed as Equation 1 below. As seen from Equation 1, the unit of the rated capacity of the battery is not considered in the C-rate.

$$C - rate = ( charging or discharging current ) [ A ] / ( rated capacity of battery ) \qquad [ Equation 1 ]$$

Hereinafter, an embodiment disclosed in the present specification will be described in detail with reference to the accompanying drawings, and the same or similar constituent factors are denoted by the same reference numeral regardless of a reference numeral, and a repeated description thereof will be omitted. Suffixes, “module” and and/or “unit” for a constituent factor used for the description below are given or mixed in consideration of only easiness of the writing of the specification, and the suffixes themselves do not have a discriminated meaning or role. Further, in describing the embodiments disclosed in the present disclosure, when it is determined that detailed descriptions relating to well-known functions or configurations may make the subject matter of the embodiments disclosed in the present disclosure unnecessarily ambiguous, the detailed description will be omitted. Further, the accompanying drawings are provided for helping to easily understand embodiments disclosed in the present specification, and the technical spirit disclosed in the present specification is not limited by the accompanying drawings, and it will be appreciated that the present invention includes all of modifications, equivalent matters, and substitutes included in the spirit and the technical scope of the present invention.

Terms including an ordinary number, such as first and second, are used for describing various constituent factors, but the constituent factors are not limited by the terms. The terms are used only to discriminate one constituent factor from another constituent factor.

In the present application, it will be appreciated that terms “including” and “having” are intended to designate the existence of characteristics, numbers, steps, operations, constituent factors, and components described in the specification or a combination thereof, and do not exclude a possibility of the existence or addition of one or more other characteristics, numbers, steps, operations, constituent factors, and components, or a combination thereof in advance.

A program implemented as a set of instructions embodying a control algorithm necessary to control another configuration may be installed in a configuration for controlling another configuration under a specific control condition among configurations according to an embodiment. The control configuration may process input data and stored data, based on the installed program to generate output data. The control configuration may include a non-volatile memory storing the program and a memory storing the data.

Hereinafter, a charging control method of a battery pack and a battery system using the same according to an embodiment will be described with reference to drawings.

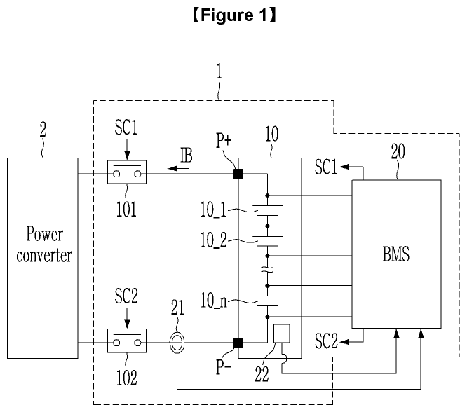

FIG. 1 is a view showing a battery system according to an embodiment.

As shown in FIG. 1, a battery system 1 is connected to a power converter 2.

The power converter 2 may supply power supplied from the battery pack 10 by the discharge of the battery pack 10 to an external load (e.g., a motor that provides driving power to an electric vehicle). Electric vehicles include vehicles driven only by a motor without an internal combustion engine and hybrid vehicles that include both an internal combustion engine and a motor.

The power converter 2 may supply the power for charging the battery pack 10 from an external commercial power source. The power converter 2 may be a charging and discharging device for testing battery performance (e.g., for motorized bicycle or the like). As such, the power converter 2 may be a device that transfers the power from the battery pack 10 to the outside or from the outside to the battery pack 10 according to the discharging or charging of the battery pack 10.

The battery system 1 includes a battery pack 10, a BMS 20, and first and second contactors 101 and 102.

The first contactor 101 is connected between a positive electrode (P+) of the battery pack 10 and the power converter 40, and is switched under the control of the BMS 20. The second contactor 102 is connected between the negative electrode (P−) of the battery pack 10 and the power converter 2, and is switched under the control of the BMS 20. The BMS 20 may generate and supply switching signals SC1 and SC2 that control the switching operations of the first and second contactors 101 and 102 to the first and second contactors 101 and 102.

The battery pack 10 includes a plurality of battery cells 10_1 to 10_n (n is two or more natural numbers) connected in series.

The BMS 20 is connected to both terminals of each of a plurality of battery cells 10_1 to 10_n. The BMS 20 may measure the cell voltage of each of a plurality of battery cells 10_1 to 10_n at each monitoring period, and may measure the current (hereinafter, a battery pack current) and temperature (hereinafter, a battery pack temperature) of the battery pack 10. The temperature of a plurality of battery cells 10_1 to 10_n may follow the battery pack temperature. However, the disclosure is not limited thereto, and a plurality of temperature sensors may be disposed in the battery pack 10, and the BMS 20 may estimate the temperature for each of a plurality of battery cells 10_1 to 10_n based on temperature information obtained from a plurality of temperature sensors. Hereinafter, in the description, the battery pack temperature may be replaced with the battery cell temperature.

The current sensor 21 may measure the battery pack current IB and transmit the information about the measured battery pack current to the BMS 20.

The temperature sensor 22 may measure the battery pack temperature and transmit the information about the measured battery pack temperature to the BMS 20.

The BMS 20 may control and perform cell balancing for a plurality of battery cells 10_1 to 10_n based on a plurality of cell voltages. The BMS 20 may estimate a state of charge (SOC), a state of health (SOH), a state of power (SOP), etc. based on a plurality of cell voltages of a plurality of battery cells 10_1 to 10_n and the measured information (the battery pack current, the battery pack temperature, etc.) of the battery pack 10.

The BMS 20 may determine a charging rate based on the charging target SOC for the battery pack 10, a plurality of cell voltages, and the battery pack temperature. The charging target SOC may be transmitted to the BMS 20 through controller area network (CAN) communication from an electronic control circuit that controls the electric vehicle when the battery system 1 is installed in the electric vehicle. Alternatively, the user may transmit the charging target SOC to the BMS 20 through the interface for the battery performance test.

The BMS 20 may include a map (hereinafter, a charging rate map) in which the charging rate is set based on the charging target SOC and the battery pack temperature. In the charging rate map, a charging rate according to each of a plurality of battery pack temperatures is defined for each of a plurality of charging targets SOC. The BMS 20 may derive a target OCV corresponding to the charging target SOC. The BMS 20 generates an error voltage, which is the difference between the target OCV and one of a plurality of cell voltages, for each monitoring period, derives a PID value based on the error voltage for each monitoring period, and multiplies the derived PID value by the charging rate determined based on the charging target SOC and the battery pack temperature to generate a compensating charging rate.

The BMS 20 transmits the compensation charging rate to the power converter 2. The power converter 2 may supply the power to the battery pack 10 according to the compensation charging rate. The BMS 20 may repeat the PID value derivation and the compensation charging rate generation described above for each monitoring period.

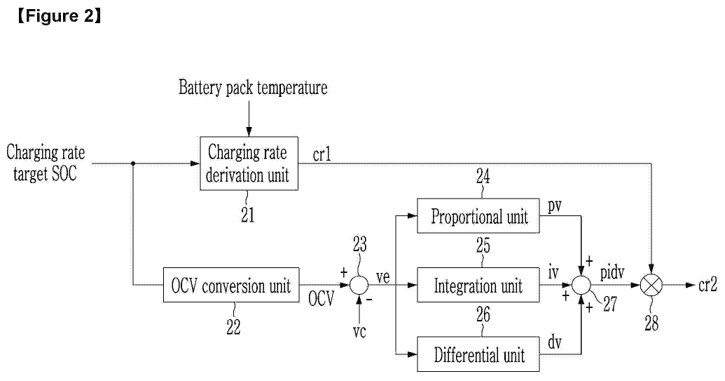

FIG. 2 is a block diagram showing some components of a BMS according to an embodiment.

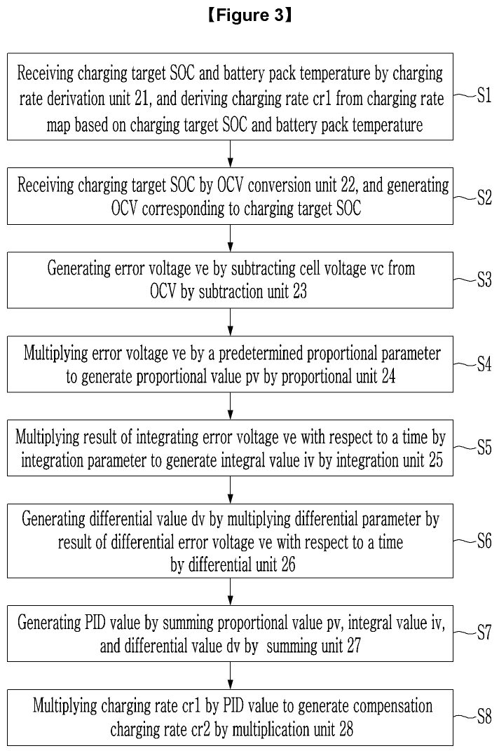

FIG. 3 is a flowchart showing an operation of a BMS according to an embodiment.

FIG. 2 shows, as configurations of the BMS 20, only configurations necessary to generate the compensation charging rate by deriving the PID value.

The BMS 20 may include a charging rate derivation unit 21, an OCV conversion unit 22, a subtraction unit 23, a proportional unit 24, an integration unit 25, a differential unit 26, a summing unit 27, and a multiplication unit 28.

Each of the components 21 to 28 constituting the BMS 20 is a module to perform a corresponding function, and a program including control instructions for performing the corresponding function may be installed in the corresponding module. Each of the charging rate derivation unit 21, the OCV conversion unit 22, the subtraction unit 23, the proportional unit 24, the integration unit 25, the differential unit 26, the summing unit 27, and the multiplication unit 28 may operate according to the installed program and generate the output according to the input.

The charging rate derivation unit 21 stores the charging rate map. The charging rate derivation unit 21 receives the charging target SOC and the battery pack temperature, and derives the charging rate cr1 from the charging rate map based on the charging target SOC and the battery pack temperature (S1).

The OCV conversion unit 22 includes a program that implements a SOC to OCV conversion function, and upon receiving the charging target SOC, it may generate the OCV corresponding to the charging target SOC using the program (S2).

The subtraction unit 23 may generate an error voltage ve by subtracting the cell voltage vc from the OCV (S3). The cell voltage vc may be a cell voltage (hereinafter, a highest cell voltage) that is highest among a plurality of cell voltages. There may be a difference between a plurality of cell voltages, and when the PID value is derived based on the lower cell voltage than the highest cell voltage among a plurality of cell voltages, overcharging may occur for the cell having the highest cell voltage. This may cause the cell voltage of the corresponding cell to become the overvoltage.

The proportional unit 24, the integration unit 25, and the differential unit 26 for deriving the PID value may receive the error voltage ve for each monitoring period. The proportional parameter, the integral parameter, and the differential parameter for deriving the PID value may be set through tuning using an experimental method.

The proportional unit 24 multiplies the error voltage ve by a predetermined proportional parameter to generate a proportional value pv (S4).

The integration unit 25 multiplies the result of integrating the error voltage ve with respect to time by the integration parameter to generate an integral value iv (S5). In this case, the integration period may be a period between the previous monitoring time point and the current monitoring time point, that is, a monitoring cycle. That is, the integration unit 25 may generate an integral value iv by multiplying an integral parameter by the result obtained by multiplying the error voltage ve by the monitoring cycle.

The differential unit 26 generates a differential value dv by multiplying the differential parameter by the result of differentiating the error voltage ve with respect to time (S6). At this time, the differential period may also be a monitoring cycle. That is, the differential unit 26 may generate a differential value dv by multiplying a value obtained by dividing a value obtained by subtracting the error voltage at the previous monitoring time point from the error voltage ve at the current monitoring time point by a monitoring cycle by a differential parameter.

The summing unit 27 generates the PID value by summing the proportional value pv, the integral value iv, and the differential value dv (S7).

The multiplication unit 28 multiplies the charging rate cr1 by the PID value to generate the compensation charging rate cr2 (S8).

The BMS 20 may transmit the compensation charging rate cr2 to the power converter 2, and the power converter 2 may charge the battery pack 10 with a charging current depending on the compensation charging rate cr2.

The BMS 20 may perform the above-described operation by measuring the cell voltages of a plurality of battery cells 10_1 to 10_n in the next monitoring cycle and deriving the highest cell voltage among a plurality of cell voltages. In this way, the BMS 20 may generate the compensation charging rate based on the highest cell voltage for each monitoring cycle. However, the present invention is not limited thereto, and the compensation charging rate may be generated for every predetermined integer multiple of the monitoring cycle.

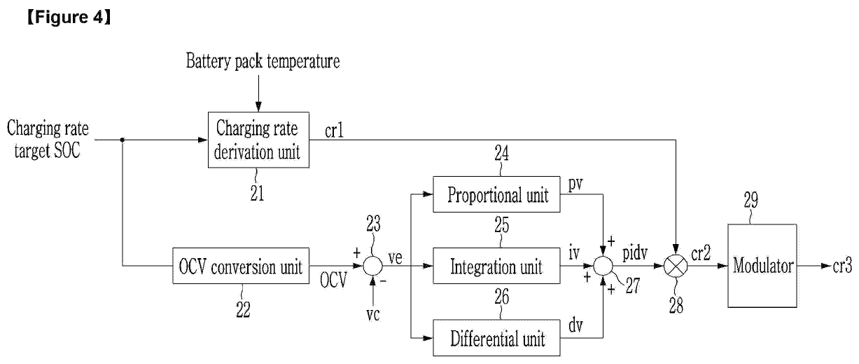

FIG. 4 is a block diagram showing a configuration of a BMS according to an embodiment.

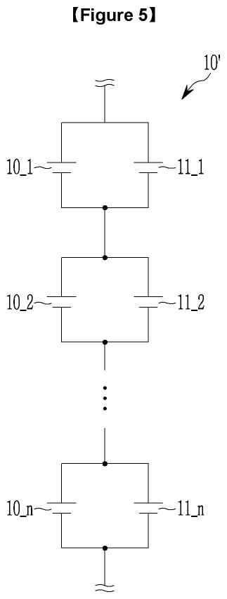

FIG. 5 is a circuit diagram showing a battery pack according to an embodiment.

Among the contents shown in FIG. 4, the contents overlapping with those shown in FIG. 2 are omitted.

As shown in FIG. 4, the BMS 20 further includes a modulator 29 compared to the preceding embodiment. The modulator 29 may modulate the compensation charging rate according to the structure of a plurality of battery cells constituting the battery pack 10.

For example, FIG. 1 shows that a plurality of battery cells 10_1 to 10_n are connected in series, but the battery pack 10′ shown in FIG. 5 may include the battery cells connected in parallel to each of a plurality of battery cells 10_1 to 10_n. One of a plurality of battery cells 10_1 to 10_n and one of a plurality of battery cells 11_1 to 11_n are connected in parallel to form a battery cell group, and the plurality of battery cell groups that are connected in parallel are connected in series. FIG. 5 is an example of a case where p battery cell groups connected in parallel with p are connected in series with s (p and s are natural numbers of 2 or more).

In the battery pack 10′ shown in FIG. 5, since two battery cells are connected in parallel, the charging current is divided into two paths and flows to each cell. Therefore, the compensation charging rate should be doubled. The modulator 29 may generate a modulation charging rate cr3 obtained by multiplying the compensation charging rate cr2 by a proportional constant 2 considering two current paths in parallel. The modulator 29 may determine a proportional constant value according to the number of battery cells connected in parallel, that is, p. For example, when the number of battery cells connected in parallel is 3, the proportional constant may be 3.

The BMS 20 may transmits the modulated charging rate cr3 to the power converter 2, and the power converter 2 may charge the battery pack 10 with the charging current according to the modulated charging rate cr3.

The conventional rapid charging method proceeds with the charging at a constant C-Rate, but reduces the current when the cell voltage exceeds the upper limit voltage. In contrast, the charging method according to an embodiment converts the charging target SOC to the OCV, sets the upper limit voltage in the charging for the charging target SOC, and controls the PID based on the error voltage between a plurality of battery cell voltages and the OCV, thereby it is possible to prevent the cell voltage from exceeding the upper limit voltage.

While this invention has been described in connection with what is presently considered to be practical embodiments, it is to be understood that the invention is not limited to the disclosed embodiments. On the contrary, it is intended to cover various modifications and equivalent arrangements included within the spirit and scope of the appended claims.

1. A battery system comprising:
a battery pack including a plurality of battery cells; and
a battery management system configured to:
derive a charging rate based on a charging target state of charge (SOC) for the battery pack and a temperature of the battery pack,
compensate the charging rate through (PID) control based on an error voltage between any one of a plurality of cell voltages of the plurality of battery cells and an open circuit voltage (OCV) corresponding to the charging target SOC to generate a compensation charging rate.

2. The battery system of claim 1, wherein
the battery management system is configured to generate a proportional value, an integral value, and a differential value based on the error voltage to derive a PID value, and multiply the charging rate by the PID value to generate the compensation charging rate.

3. The battery system of claim 2, wherein the battery management system is configured to derive the PID value by adding the proportional value, the integral value, and the differential value.

4. The battery system of claim 1, wherein
the battery management system includes a charging rate map in which a charging rate corresponding to each temperature of a plurality of battery packs is defined for each of a plurality of charging target SOCs, and
the battery management system is configured to receive the charging target SOCs and the temperature of the battery pack, and derive the charging rate corresponding to the received charging target SOCs and battery pack temperature from the charging rate map.

5. The battery system of claim 1, wherein
the battery management system is configured to generate the OCV corresponding to the charging target SOC by using an SOC to OCV conversion function.

6. The battery system of claim 1, wherein
the battery management system is configured to generate the error voltage by subtracting a highest cell voltage among the plurality of cell voltages from the OCV.

7. The battery system of claim 1, wherein
the battery system includes battery cell groups including battery cells among the plurality of battery cells connected in parallel, and the battery cell groups are connected to each other in series, and
the battery management system is configured to generate a modulation charging rate by multiplying the compensation charging rate by the number of battery cell groups.

8. A charging method of a battery pack including a plurality of battery cells controlled by a battery management system, the charging method comprising:
deriving a charging rate based on a charging target state of charge (SOC) for the battery pack and a temperature of the battery pack:
generating an error voltage between any one of the a plurality of cell voltages and an open circuit voltage (OCV) corresponding to the charging target SOC; and
generating a compensation charging rate by compensating for the charging rate through proportional-integral-derivative (PID) control based on the error voltage.

9. The charging control method of the battery pack of claim 8, wherein
the generating of the compensation charging rate includes:
generating a proportional value, an integral value, and a differential value based on the error voltage;
deriving the PID value by adding the proportional value, the integral value, and the differential value; and
multiplying the charging rate by the PID value to generate the compensation charging rate.

10. The charging control method of the battery pack of claim 8, wherein
the deriving of the charging rate includes:
receiving the charging target SOC and the battery pack temperature; and
deriving the charging rate corresponding to the received charging target SOC and the temperature of the battery pack from a charging rate map.

11. The charging control method of the battery pack of claim 8. further comprising
generating the OCV corresponding to the charging target SOC by using an SOC to OCV conversion function.

12. The charging control method of the battery pack of claim 8, wherein
the generating of the error voltage includes:
generating the error voltage by subtracting a highest cell voltage among the plurality of cell voltages from the OCV.

13. The charging control method of the battery pack of claim 8, wherein the battery system includes battery cell groups including battery cells among the plurality of battery cells connected in parallel, and the battery cell groups are connected to each other in series, and
wherein the method further comprises:
generating a modulation charging rate by multiplying the compensation charging rate by the number of battery cell groups.
